(19) United States
(12) Patent Application Publication
(10) Pub. No.: US 2023/0166177 A1
(43) Pub. Date: Jun. 1, 2023

(54) PLAYMAT

(71) Applicant: Ultra PRO International, Commerce, CA (US)

(72) Inventors: George Stetar, Commerce, CA (US); Justin Cole, Commerce, CA (US)

(21) Appl. No.: 17/536,224

(22) Filed: Nov. 29, 2021

(51) Int. Cl. A63F 9/00; B32B 25/10; B32B 25/14; B32B 25/12; B32B 27/36; B32B 27/12; B32B 7/09

(52) U.S. Cl. CPC A63F 9/001; B32B 25/10; B32B 25/14; B32B 25/12; B32B 27/36; B32B 27/12; B32B 7/09; A63F 2009/0047; B32B 2250/03; B32B 2255/205; B32B 2255/10; B32B 2307/718; B44F 1/00

(57) ABSTRACT

Provided is a protective playmat comprising a first layer of natural rubber foam or neoprene foam or both, the first layer having a first layer top surface and a non-slip first layer bottom surface opposite said first layer top surface; a second layer comprising a second layer top surface and a second layer bottom surface opposite said second layer top surface, the second layer bottom surface being laminated to the first layer top surface, the second layer including a textured polyester cloth blend of between 150gsm and 250gsm; and a third layer comprising a third layer top surface and a third layer bottom surface opposite said third layer top surface, the third layer bottom surface being laminated to the second layer top surface, the third layer including an electrochemical aluminum foil on PET film forming silver dots or holographic dots or both.

### CROSS-REFERENCE TO RELATED APPLICATIONS

No related applications exist.

### BACKGROUND

There is a need for mat, playmats, adapted for playing card games.

Players of card games sometimes use a playmat over table, desk or other surface to form a desired surface upon which to display cards as part of play of a card game.

A playmat may be protective in nature, a protective playmat, and may protect the table, desk or other surface upon which it is adapted to be placed during use; and may also protect the cards played upon it.

It remains desirable to provide a protective playmat which is more durable, more inexpensive, more attractive, more easy to maintain, more easy to use, lighter, or some combination thereof, as compared to the existing art. Improvements over the existing art in these aspects remain to me made.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

Accordingly, the present subject matter is directed to a playmat that substantially obviates one or more problems resulting from the limitations and deficiencies of the related art.

In accordance with one non-limiting embodiment of the present invention, there is provided a protective playmat comprising a first layer of natural rubber foam or neoprene foam or both, the first layer having a first layer top surface and a non-slip first layer bottom surface opposite said first layer top surface; a second layer comprising a second layer top surface and a second layer bottom surface opposite said second layer top surface, the second layer bottom surface being laminated to the first layer top surface, the second layer including a textured polyester cloth blend of between 150 gsm and 250 gsm; and a third layer comprising a third layer top surface and a third layer bottom surface opposite said third layer top surface, the third layer bottom surface being laminated to the second layer top surface, the third layer including an electrochemical aluminum foil on PET film forming silver dots or holographic dots or both.

In accordance with one non-limiting embodiment of the present invention, there is provided a method of playing a card game comprising, providing a protective playmat having a first layer of natural rubber foam or neoprene foam or both, the first layer having a first layer top surface and a non-slip first layer bottom surface opposite said first layer top surface, a second layer comprising a second layer top surface and a second layer bottom surface opposite said second layer top surface, the second layer bottom surface being laminated to the first layer top surface, the second layer including a textured polyester cloth blend of between 150 gsm and 250 gsm, and a third layer comprising a third layer top surface and a third layer bottom surface opposite said third layer top surface, the third layer bottom surface being laminated to the second layer top surface, the third layer including an electrochemical aluminum foil on PET film forming silver dots or holographic dots or both; providing a plurality of playing cards; and displaying the playing cards on the third layer top surface.

It is to be understood that the foregoing general description and the following detailed description of the present subject matter are merely exemplary and explanatory in nature. As such, the foregoing general description and the following detailed description should not be construed to limit the scope of the appended claims in any sense.

### BRIEF DESCRIPTION OF THE DRAWINGS

Various exemplary embodiments of the present subject matter will be described in detail, wherein like reference numerals refer to identical or similar components, with reference to the following figures, wherein:

FIG. 1 is a top view of a playmat, according to a first embodiment thereof;

FIG. 2 is a front view of the playmat of FIG. 1;

FIG. 3 is a right side view of the playmat of FIG. 1;

FIG. 4 is close up sectional view of the playmat of FIG. 1;

Throughout the figures, unless otherwise noted, the same parts are denoted using the same reference characters so that, as a general rule, they will only be described once.

### DETAILED DESCRIPTION

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

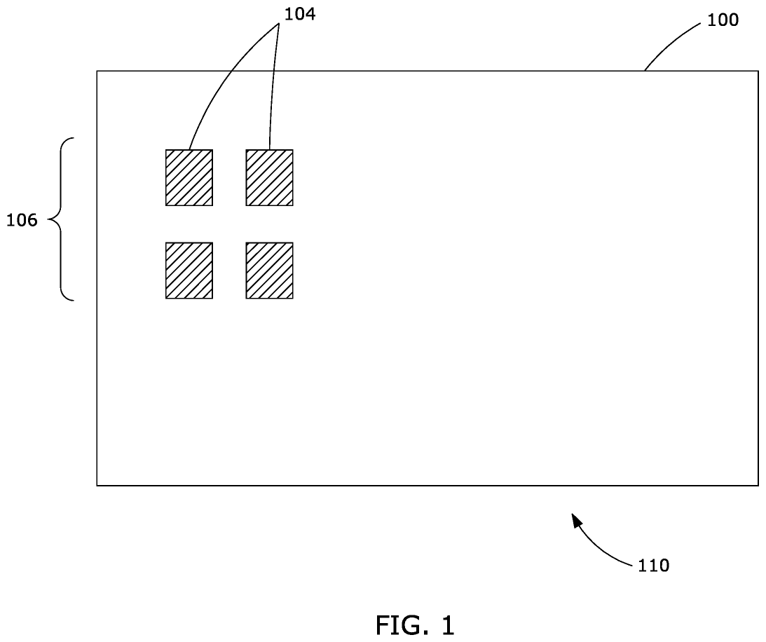

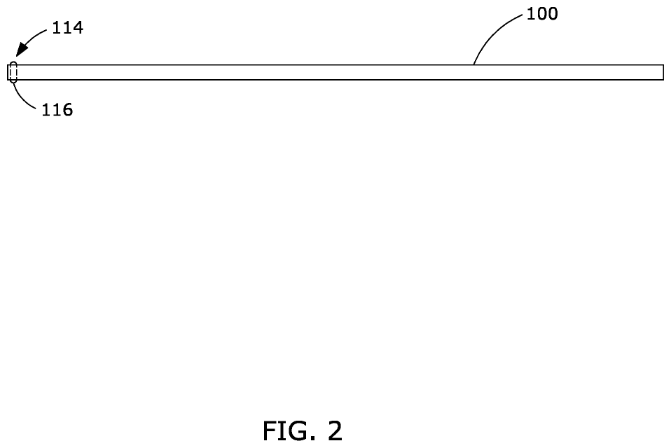

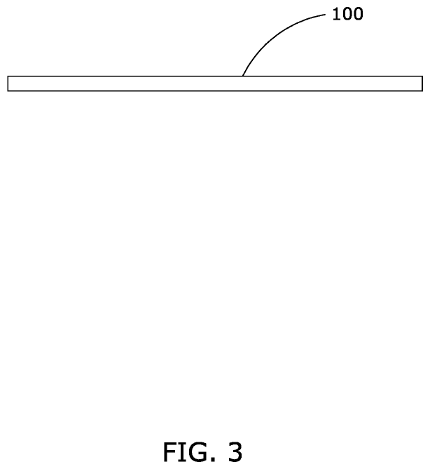

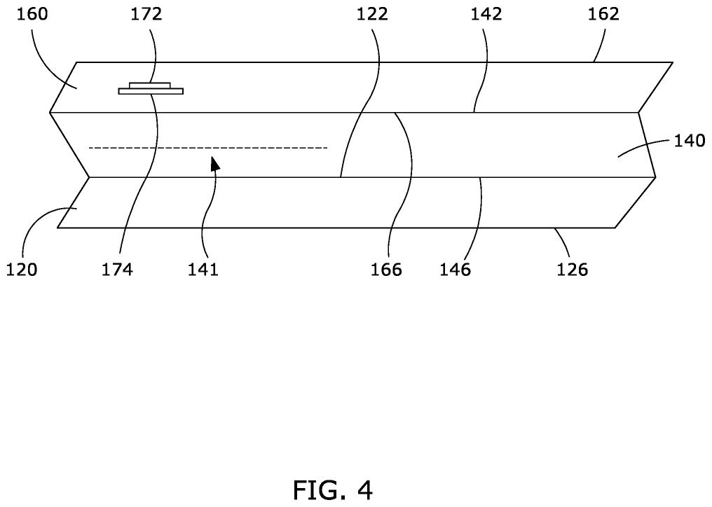

An illustrative first embodiment of a playmat is seen generally in FIGS. 1-4. The playmat 100 generally comprises a first layer 120, a second layer 140, and a third layer 160.

The first layer 120 may comprise an elastomeric foam chosen with good engineering judgment. In some embodiments the first layer 120 comprises natural rubber foam, or neoprene foam, or both. In some embodiments, the first layer 120 may comprise a first layer top surface 122 and a first layer bottom surface 126 opposite said first layer top surface 122. In some embodiments, the first layer bottom surface 126 is adapted to be non-slip.

The second layer 140 may comprise a second layer top surface 142 and a second layer bottom surface 146 opposite said second layer top surface 142. The second layer bottom surface 146 may be engaged to the first layer top surface 122 by a method chosen with good engineering judgment such as by use of an adhesive or by being laminated thereto.

In some non-limiting embodiments, the second layer 140 may comprise a cloth 141. In some non-limiting embodiments, cloth 141 may comprise a nylon cloth, and aramid cloth, a polyester cloth, or a cloth comprising a mixture of synthetic or non-synthetic fiber. In some non-limiting embodiments, cloth 141 may comprise a textured polyester cloth. In some non-limiting embodiments, the second layer 140 may comprise a cloth 141 comprising a textured polyester cloth blend of between 50 grams per square meter (gsm) and 500 gsm. In some non-limiting embodiments, the second layer 140 may comprise a cloth 141 comprising a textured polyester cloth blend of between 150 gsm and 250 gsm. In some non-limiting embodiments, the second layer 140 may comprise a cloth 141 comprising a textured polyester cloth blend of between 190 gsm and 210 gsm.

The third layer 160 may comprise a third layer top surface 162 and a third layer bottom surface 166 opposite said third layer top surface 162. The third layer third layer bottom surface 166 may be engaged to the second layer top surface 142 by a method chosen with good engineering judgment such as by use of an adhesive or by being laminated thereto.

The third layer 160 may comprise an electrochemical aluminum foil 172 on a film 174. The film 174 may, in certain embodiments, be chemically similar to, or identical to, the cloth 141 where each comprises the same or similar compounds, such as, and without limitation, polyethylene terephthalate or nylon. Here, chemically similar means compounds that do not differ by more than common commercial manufacturing tolerances based on good engineering judgment. In certain embodiments, the third layer 160 may comprise an electrochemical aluminum foil 172 on polyethylene terephthalate (PET) film 174. In embodiment comprising such, the latter electrochemical aluminum foil 172 on film 174 may form silver dots or holographic dots or both.

In some embodiments, the playmat 100 may have the generally rectangular shape shown in FIG. 1, but this is not limiting and it is to be understood that that in other equally acceptable embodiments other shapes, square, circular, elliptical, hexagonal, octagonal, stylized forms, etc. are also contemplated. In some embodiments, the playmat 100 may have the square corners shown in FIG. 1, but this is not limiting, and it is to be understood that in other equally acceptable embodiments other corner forms are contemplated, such as, and without limitation, rounded off (filleted) corners, chamfered corners, etc. In some embodiments, the playmat 100 defines a perimeter 110. Perimeter 110 may comprise additional features such as a lip, or edge, or stitching 114. Stitching 114 may comprise a thread 116, such as, and without limitation, a nylon thread, an aramid thread, or a polyester thread.

The playmat 100 may be adapted for playing card games thereon. In certain embodiments, a playmat adapted for playing card games thereon will be of sufficient size to permit a card 106 or an array of playing cards 104 to be laid out on the playmat 100 and displayed thereon. In certain embodiments, an array of playing cards may be two dimensional and describable by a numerical product of two integers in the form of N×M, but other display forms are contemplated with card display being a function of additional parameters such as, orientation on the playmat, facing (up/down) on the playmat, position on the playmat, etc. Associated playing cards of interest to be used with the playmat 100 include not only standard sized commercial 2.5″×3.5″ playing cards but also larger and smaller sized playing cards, Tarot cards, and cards made for specific games. In certain embodiments, a playmat adapted for playing card games thereon will be of sufficient size to permit a 5×2 array of 2.5″×3.5″ playing cards to be displayed on the third layer top surface.

In some embodiments, and without limitation, the playmat 100 is substantially rectangular and at least 30″×20″. In some embodiments, and without limitation, the playmat 100 is substantially rectangular and at least 25″×15″. In some embodiments, and without limitation, the playmat 100 is substantially rectangular and at least 20″×12″. In some embodiments, and without limitation, the playmat 100 is substantially rectangular and at least 15″×10″.

Provided is method of playing a card game comprising, providing a protective playmat 100, providing a plurality of playing cards 104; and displaying the playing cards 104 on a top surface of the playmat 100 such as, the third layer top surface 162.

In such methods, the playmat 100 may comprise a first layer of natural rubber foam or neoprene foam or both, the first layer having a first layer top surface and a non-slip first layer bottom surface opposite said first layer top surface. The second layer may comprise a second layer top surface and a second layer bottom surface opposite said second layer top surface, the second layer bottom surface being laminated to the first layer top surface, the second layer including a textured polyester cloth blend of between 150 gsm and 250 gsm. The third layer may comprise a third layer top surface and a third layer bottom surface opposite said third layer top surface, the third layer bottom surface being laminated to the second layer top surface, the third layer including an electrochemical aluminum foil on PET film forming silver dots or holographic dots or both.

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

1. A protective playmat comprising
a first layer of natural rubber foam or neoprene foam or both, the first layer having a first layer top surface and a non-slip first layer bottom surface opposite said first layer top surface;
a second layer comprising a second layer top surface and a second layer bottom surface opposite said second layer top surface, the second layer bottom surface being laminated to the first layer top surface, the second layer including a textured polyester cloth blend of between 150 gsm and 250 gsm; and
a third layer comprising a third layer top surface and a third layer bottom surface opposite said third layer top surface, the third layer bottom surface being laminated to the second layer top surface, the third layer including an electrochemical aluminum foil on PET film forming silver dots or holographic dots or both.

2. The protective playmat of claim 1, wherein the playmat is adapted for playing card games thereon.

3. The protective playmat of claim 1, wherein the playmat defines perimeter stitched with a thread.

4. The protective playmat of claim 2, wherein the playmat defines perimeter stitched with a thread.

5. The protective playmat of claim 4, wherein the playmat is substantially rectangular.

6. The protective playmat of claim 1, wherein the playmat is of at least sufficient size to permit a 5×2 array of 2.5″×3.5″ playing cards to be displayed on the third layer top surface.

7. The protective playmat of claim 5, wherein the playmat is of at least sufficient size to permit a 5×2 array of 2.5″×3.5″ playing cards to be displayed on the third layer top surface.

8. The protective playmat of claim 7, wherein the playmat is at least 15″×10″.

9. The protective playmat of claim 1,
wherein the playmat is adapted for playing card games thereon;
wherein the playmat defines perimeter stitched with a thread;
wherein the playmat is substantially rectangular; and
wherein the playmat is at least 15″×10″.

10. The protective playmat of claim 9, wherein thread comprises polyester.

11. A method of playing a card game comprising,
providing a protective playmat having
a first layer of natural rubber foam or neoprene foam or both, the first layer having a first layer top surface and a non-slip first layer bottom surface opposite said first layer top surface,
a second layer comprising a second layer top surface and a second layer bottom surface opposite said second layer top surface, the second layer bottom surface being laminated to the first layer top surface, the second layer including a textured polyester cloth blend of between 150 gsm and 250 gsm, and
a third layer comprising a third layer top surface and a third layer bottom surface opposite said third layer top surface, the third layer bottom surface being laminated to the second layer top surface, the third layer including an electrochemical aluminum foil on PET film forming silver dots or holographic dots or both;
providing a plurality of playing cards; and
displaying the playing cards on the third layer top surface.

12. The method of playing a card game of claim 11, wherein the playmat defines a perimeter stitched with a thread.

13. The method of playing a card game of claim 12, wherein the playmat is substantially rectangular.

14. The method of playing a card game of claim 13, wherein the plurality of playing cards comprises a plurality of 2.5″×3.5″ playing cards.

15. The method of playing a card game of claim 14, wherein the playmat is of at least sufficient size to permit a 5×2 array of the 2.5″×3.5″ playing cards to be displayed on the third layer top surface.

16. The method of playing a card game of claim 15, wherein the playmat is at least 15″×10″.

17. The method of playing a card game of claim 11,
wherein the playmat defines perimeter stitched with a thread;
wherein the playmat is substantially rectangular; and
wherein the playmat is at least 15″×10″.

18. The protective playmat of claim 17, wherein thread comprises polyester.
